(19) United States
(12) Patent Application Publication
(10) Pub. No.: US 2026/0088313 A1
(43) Pub. Date: Mar. 26, 2026

(54) BIPOLAR PLATE AND ELECTROCHEMICAL CELL

(71) Applicant: Schaeffler Technologies AG & Co. KG, Herzogenaurach (DE)

(72) Inventor: Sebastian Zwahr, Obermichelbach (DE)

(21) Appl. No.: 19/109,510

(22) PCT Filed: Apr. 25, 2023
(86) PCT No.: PCT/DE2023/100296

§ 371 Date: Mar. 6, 2025

(30) Foreign Application Priority Data
Sep. 7, 2022 (DE) 10 2022 122 717.0

(51) Int. Cl. H01M 8/0258; C25B 9/19; C25B 9/77; C25B 13/02; H01M 8/10; H01M 8/1004

(52) U.S. Cl. CPC H01M 8/0258; C25B 9/19; C25B 9/77; C25B 13/02; H01M 8/1004; H01M 2008/1095

(57) ABSTRACT

The invention relates to a bipolar plate and an electrochemical cell comprising a plurality of such bipolar plates. The bipolar plate comprises a first half-plate and a second half-plate which are fixedly connected to one another, wherein the bipolar plate has a plurality of fluid passage openings comprising fluid inlet openings and fluid outlet openings and a first distributor field for distributing a fluid, an active field, and a second distributor field for distributing the fluid are located on both sides of the bipolar plate.

### CROSS-REFERENCE TO RELATED APPLICATION

The present application is the U.S. National Phase of PCT Patent Application Number PCT/DE2023/100296, filed on Apr. 25, 2023, which claims priority to German Patent Application Number 10 2022 122 717.0, filed Sep. 7, 2022, the entire disclosures of which are incorporated by reference herein.

### TECHNICAL FIELD

The disclosure relates to a bipolar plate comprising a first half-sheet and a second half-sheet, which are fixedly connected to one another, wherein the bipolar plate has a plurality of fluid passage openings comprising fluid inlet openings and fluid outlet openings, and a first distributor field for distributing a fluid, an active field and a second distributor field for distributing the fluid are arranged on both sides of the bipolar plate, and having at least one seal on each side of the bipolar plate, a transition region being formed between a fluid passage opening and an adjacent distributor field.

### BACKGROUND

DE 10 2014 225 160 A1 describes a metal separator, i.e. a bipolar plate, for a fuel cell stack with an anode separator and a cathode separator. In particular, DE 10 2014 225 160 A1 describes an embodiment of a transition region which is formed in the metal separator between a fluid passage opening and an active region (not shown in detail) in which electrochemical reactions take place. The metal separator has a seal on both sides, with the seals arranged offset from one another. Support elements embossed into the separators are also arranged at the inlet and outlet of the metal separator and form channels for the fluids for operating the fuel cell stack.

CN208722997 U discloses a bipolar plate for a fuel cell with an anode plate and a cathode plate and its design in a transition region between a fluid passage opening and a reaction region in which electrochemical reactions take place. The seals arranged on both sides of the bipolar plate are offset from one another and each arranged in an elongated recess or bead.

DE 10 2020 202 075 A1 describes an electrochemical cell with a supply device or bipolar plate comprising a first and a second circuit board for supplying operating media from a fluid passage opening, here called a port connection, into a supply region. The circuit boards are designed with beads to accommodate seals that are arranged offset from one another.

### SUMMARY

It is the object of the disclosure to optimize a bipolar plate of the aforementioned type with respect to pressure loss occurring and a sealing effect of the seals in the transition region. Another object of the disclosure is to provide an electrochemical cell with bipolar plates improved in such a manner.

The object is achieved for the bipolar plate comprising a first half-sheet and a second half-sheet, which are fixedly connected to one another, in that the bipolar plate has a plurality of fluid passage openings comprising fluid inlet openings and fluid outlet openings, wherein a first distributor field for distributing a fluid, an active field and a second distributor field for distributing the fluid are arranged on both sides of the bipolar plate, and having at least one seal on each side of the bipolar plate, and in at least one transition region between a fluid passage opening and an adjacent distributor field
the first half-sheet is provided with a first step and a second step in the direction of the second half-sheet, starting from a fluid inlet opening,
the second half-sheet is provided with a third step in the region of the first step in the direction of the first half-sheet, starting from the fluid inlet opening, and is provided with a fourth step in the region of the second step, which fourth step is directed away from the first half-sheet,
the first half-sheet in a region between the first step and the second step has elongated three-dimensional first embossed structures which are oriented parallel to one another and which are curved in the direction of the second half-sheet,
the second half-sheet has, in a region between the third step and the fourth step, elongated three-dimensional second embossed structures which are oriented parallel to one another and which are curved in the direction of the first half-sheet, are arranged in alignment with the first embossed structures and are supported against the first embossed structures,
the first half-sheet has a first sealing region which is formed in the region of the first embossed structures on the side of the first half-sheet facing away from the second half-sheet and is arranged to run transverse to the first embossed structures and fill them,
the second half-sheet has a second sealing region which is arranged in the region of the second embossed structures on the side of the second half-sheet facing away from the first half-sheet so as to run transverse to the second embossed structures and fill them, the first sealing region and the second sealing region being arranged congruently one above the other when viewed perpendicular to a plane spanned by the bipolar plate, and
the second half-sheet has an opening slot which is arranged between the fourth step and the adjacent distributor field, three-dimensional third embossed structures being present which are curved in the direction of the first half-sheet, are arranged in alignment with the second embossed structures in a fluid flow direction and are supported against the first half-sheet, and the opening slot being arranged such that the third embossed structures arranged in the second half-sheet are intersected by the latter.

Because the seals on the two half-sheets run congruently one above the other in the transition region between a distributor field and a fluid passage opening and, additionally, the first and second embossed structures are filled and stiffened by the sealing material, the sealing effect on components adjacent to a bipolar plate in the region of the fluid passage openings is considerably increased. The term “congruent” means that the center lines of the first sealing region and second sealing region lie one above the other when viewed perpendicular to the plane spanned by the bipolar plate. However, the width of the first sealing region and the second sealing region may differ slightly. A cell stack of electrochemical cells can thus be constructed with defined compression of the seals. The sealing material can also be applied more precisely to the half-sheets in the transition region due to the introduced first and second embossed structures and the improved support of the half-sheet. Owing to the first and second embossed structures, the distance between the first and second half-sheets is so large that the flow can be guided with little pressure loss.

It has proven to be useful if, in at least one transition region between a fluid passage opening and an adjacent distributor field,
the first half-sheet is provided with a third step and a fourth step in the direction of the second half-sheet, starting from a fluid outlet opening,
the second half-sheet is provided in the region of the third step in the first half-sheet with a first step in the direction of the first half-sheet, starting from the fluid outlet opening, and is provided in the region of the fourth step in the first half-sheet with a second step which is directed away from the first half-sheet,
the first half-sheet has, in a region between its third step and its fourth step, elongated three-dimensional further first embossed structures which are oriented parallel to one another and are curved in the direction of the second half-sheet,
the second half-sheet has, in a region between its first step and its second step, elongated three-dimensional further second embossed structures which are oriented parallel to one another and are curved in the direction of the first half-sheet, are arranged in alignment with the further first embossed structures and are supported against the further first embossed structures,
the first half-sheet has a third sealing region, which is formed in the region of the further first embossed structures on the side of the first half-sheet facing away from the second half-sheet and is arranged to run transverse to the further first embossed structures and fill them,
the second half-sheet has a fourth sealing region, which is arranged in the region of the further second embossed structures on the side of the second half-sheet facing away from the first half-sheet so as to run transverse to the further second embossed structures and fill them, and the third sealing region and the fourth sealing region are arranged congruently one above the other when viewed perpendicular to the plane spanned by the bipolar plate, and
the second half-sheet has a further opening slot which is arranged between its second step and the adjacent distributor field, and there are three-dimensional further third embossed structures which are curved in the direction of the first half-sheet, are arranged in alignment with the further second embossed structures in a fluid flow direction and are supported against the first half-sheet, and the further opening slot is arranged such that the further third embossed structures arranged in the second half-sheet are intersected by it.

The advantages of this arrangement in the region of a fluid outlet opening are analogous to those described above for the fluid inlet opening. In this case, “congruent” also means that the center lines of the third and fourth sealing regions lie one above the other when viewed perpendicular to the plane spanned by the bipolar plate. However, the width of the third sealing region and the fourth sealing region may differ slightly.

In the transition region between a distributor field and a fluid passage opening, there is an opening slot on each side of the bipolar plate, from which opening slot a fluid is guided from a fluid inlet opening via the opening slot in the direction of the distributor field and the active field. Furthermore, in the transition region between a distributor field and a fluid passage opening on the same side of the bipolar plate there is another opening slot through which the fluid coming from the active field is guided via another distributor field in the direction of a fluid outlet opening. An oxidizing agent is supplied to an active field on a first side of the bipolar plate and a fuel is supplied to a further active field on an opposite second side of the bipolar plate.

It has proven particularly effective if the first sealing region and the third sealing region are each designed as flat seals. The second sealing region and the fourth sealing region, on the other hand, preferably each have two parallel sealing bulges. When building a cell stack, this improves the sealing tightness and optimizes the compression of the seals of the stacked bipolar plates.

The first embossed structures and the second embossed structures are preferably oriented with their longitudinal axes in the direction of a fluid flow direction between the fluid passage opening and the adjacent distributor field. The first and second embossed structures are preferably elongated in a straight line and have a constant width and length so that they optimally support each other.

A first fluid inlet opening for supplying and a first fluid outlet opening for discharging oxidizing gas are preferably configured on a first side of the bipolar plate. A second fluid inlet opening for supplying and a second fluid outlet opening for discharging fuel gas are preferably configured on a second side of the bipolar plate.

In particular, each half-sheet of the bipolar plate is three-dimensionally structured in the region of the first distributor field, the active field and the second distributor field so as to form fluid guide paths. Such structuring is achieved in particular by embossing the half-sheets. Structuring can be achieved by forming channels, locally delimited elevations or recesses, and the like.

A fluid guide path for a coolant is preferably formed between the first half-sheet and the second half-sheet of the bipolar plate. Said coolant is fed via a fluid inlet opening. A fluid outlet opening is used to discharge the coolant.

The object is further achieved for an electrochemical cell comprising a plurality of bipolar plates according to the disclosure and a membrane electrode unit arranged in each case between two bipolar plates, the membrane electrode unit being covered on both sides in each case by a fluid transport layer.

The electrochemical cell is preferably an electrolysis cell for the electrolysis of water or a polymer electrolyte fuel cell for the decomposition of water into hydrogen as fuel and oxygen as oxidizing gas.

In an electrolysis cell, a fluid transport layer is also referred to as a porous transport layer, or PTL for short. In a fuel cell, a fluid transport layer is often referred to as a gas diffusion layer, or GDL for short.

A stack arrangement comprising a plurality of fuel cells or electrolysis cells can also be formed.

### BRIEF DESCRIPTION OF THE DRAWINGS

FIGS. 1 to 9 are intended to explain the disclosure by way of example. In the drawings:

FIG. 1 shows a bipolar plate in plan view from one side;

FIG. 2 shows a cross section II-II′ through the bipolar plate from FIG. 1 in the region of a fluid inlet opening;

FIG. 3 shows a plan view of the section of the bipolar plate according to FIG. 2;

FIG. 4 shows a side view of the section of the bipolar plate according to FIG. 2 as viewed from the side of the fluid inlet opening;

FIG. 5 shows a side view of the section of the bipolar plate according to FIG. 2 as viewed from the side of the distributor field;

FIG. 6 shows a three-dimensional view of the section of the bipolar plate according to FIG. 2 without showing the seal 6′;

FIG. 7 shows a three-dimensional view of the section of the bipolar plate according to FIG. 2 with the seal 6′;

FIG. 8 shows a cross section III-III′ through the bipolar plate from FIG. 1 in the region of a fluid outlet opening;

FIG. 9 shows a schematic three-dimensional representation of a stack arrangement of electrochemical cells.

### DETAILED DESCRIPTION

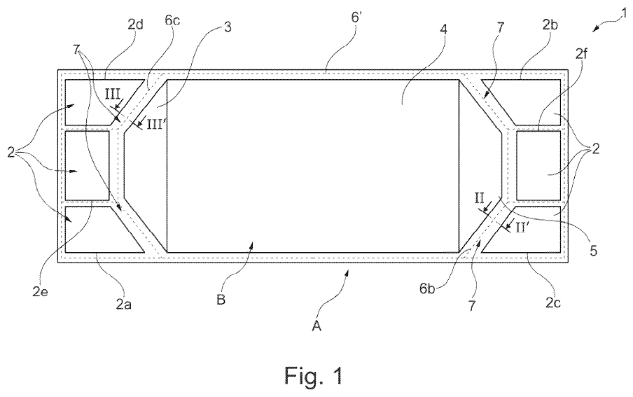

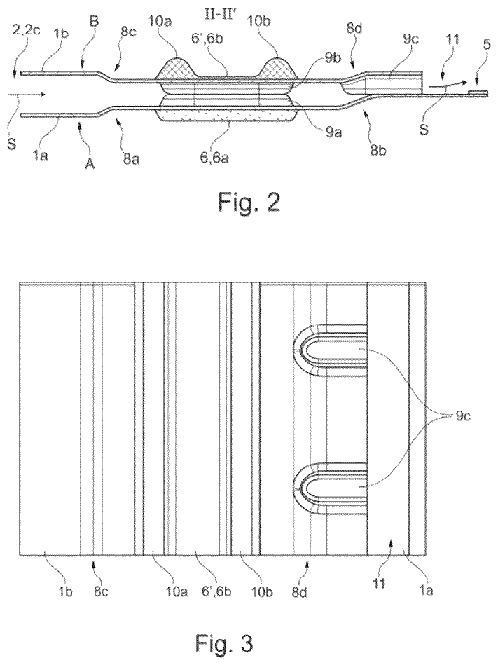

FIG. 1 shows a rectangular bipolar plate 1 in plan view from one side B. The bipolar plate 1 comprises a first half-sheet 1a and a second half-sheet 1b (see FIG. 2), which are fixedly connected to one another, for example by welding, adhesive bonding or the like. The bipolar plate 1 further comprises a plurality of fluid passage openings 2 which are arranged at both ends of the rectangular bipolar plate 1. The fluid passage openings 2 comprise fluid inlet openings 2a, 2c, 2e and fluid outlet openings 2b, 2d, 2f. Between the fluid passage openings 2 there is a first distributor field 3 for distributing a fluid, an active field 4 and a second distributor field 5 for distributing the fluid. This arrangement of fluid passage openings 2, distributor fields 3, 5 and active field 4 is also in alignment on the second side A of the bipolar plate 1. The bipolar plate 1 has at least one seal 6, 6′on each side A, B (see FIG. 2), the profile of which is indicated here as a dashed line for the sake of better clarity. The seal 6, 6′runs around the periphery of each half-plate 1a, 1b and further around each of the fluid passage openings 2.

A section II-II′ is arranged in a transition region 7 between the fluid inlet opening 2c for fuel and the adjacent distributor field 5 and is shown in FIG. 2.

There it can be seen that the first half-sheet 1a is provided with a first step 8a and a second step 8b in the direction of the second half-sheet 1b, starting from the fluid inlet opening 2c. The second half-sheet 1b is provided in the region of the first step 8a with a third step 8c in the direction of the first half-sheet 1a, starting from the fluid inlet opening 2c, and in the region of the second step 8b with a fourth step 8c which is directed away from the first half-sheet 1a. In a region between the first step 8a and the second step 8b, the first half-sheet 1a has elongated three-dimensional first embossed structures 9a which are oriented parallel to one another and are curved in the direction of the second half-sheet 1b. In a region between the third step 8c and the fourth step 8d, the second half-sheet 1b has elongated three-dimensional second embossed structures 9b that are oriented parallel to one another, are curved in the direction of the first half-sheet 1a, are arranged in alignment with the first embossed structures 9a and are supported against the first embossed structures 9a. The first half-sheet 1a has a first sealing region 6a in the form of a flat seal, which is formed in the region of the first embossed structures 9a on the side of the first half-sheet 1a facing away from the second half-sheet 1b and is arranged to run transverse to the first embossed structures 9a and to fill them. The first embossed structures 9a are filled accordingly with sealing compound and stiffened.

The second half-sheet 1b has a second sealing region 6b which has two parallel sealing bulges 10a, 10b and which is arranged in the region of the second embossed structures 9b on the side of the second half-sheet 1b facing away from the first half-sheet 1a so as to run transverse to the second embossed structures 9b and fill them. The second embossed structures 9b are also filled accordingly with sealing compound and stiffened.

The first sealing region 6a and the second sealing region 6b lie congruently one above the other when viewed perpendicular to a plane spanned by the bipolar plate 1 and thus run parallel on side A and the B of the bipolar plate 1. The second half-sheet 1b has an opening slot 11 which is arranged between the fourth step 8d and the adjacent distributor field 5, and there are three-dimensional third embossed structures 9c which are curved in the direction of the first half-sheet 1a. The third embossed structures 9c are arranged in alignment with the second embossed structures 9b in a fluid flow direction S and are supported against the first half-sheet 1a. The opening slot 11 is arranged such that the third embossed structures 9c arranged in the second half-sheet 1b are intersected by it. Accordingly, during the formation of the opening slot 11, a part of the second half-sheet 1b was separated out which contained a part of the previously formed third embossed structures 9c.

FIG. 3 shows a plan view of the section of the bipolar plate 1 according to FIG. 2. The same reference signs as in FIG. 2 indicate identical elements.

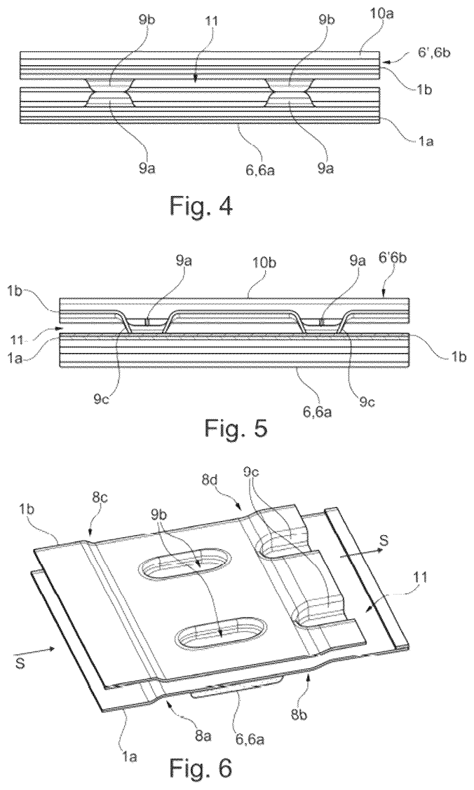

FIG. 4 shows a side view of the section of the bipolar plate 1 according to FIG. 2 as viewed from the side of the fluid inlet opening 2c. The same reference signs as in FIG. 2 indicate identical elements. The first embossed structures 9a and the second embossed structures 9b can now be clearly seen, which support each other and form a flow channel for a fluid between the two half-sheets 1a, 1b. The flow channel runs towards the opening slot 11.

FIG. 5 shows a side view of the section of the bipolar plate 1 according to FIG. 2 as viewed from the side of the distributor field 5. The same reference signs as in FIG. 2 indicate identical elements. The third embossed structures 9c and the opening slot 11, which allows a fluid to flow between the two half-sheets 1a, 1b, can now be clearly seen.

FIG. 6 shows a three-dimensional view of the section of the bipolar plate 1 according to FIG. 2 without showing the seal 6′or the second sealing region 6b. In the second half-plate 1b, the elongated second embossed structures 9b and the third embossed structures 9c can be seen, which are arranged one behind the other in alignment in the fluid flow direction S. The first embossed structures 9a in the first half-sheet 1a cannot be seen here. The same reference signs as in FIG. 2 indicate identical elements.

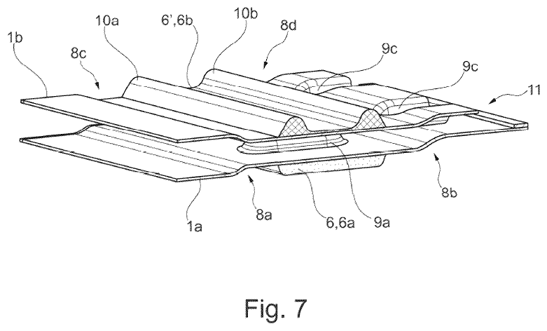

FIG. 7 shows a three-dimensional view of the section of the bipolar plate 1 according to FIG. 2 with the seal 6′or the second sealing portion 6b. The first embossed structures 9a in the first half-sheet 1a and the third embossed structures 9c in the second half-sheet 1b can be seen here. The second embossed structures 9b in the second half-sheet 1b cannot be seen here and are covered by the seal 6′. The same reference signs as in FIG. 2 indicate identical elements.

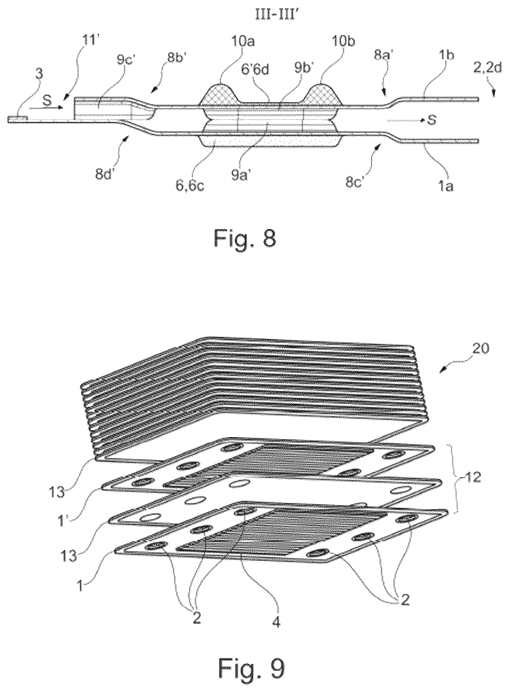

FIG. 8 shows a cross section III-III′ through the bipolar plate 1 from FIG. 1 in the region of a fluid outlet opening 2d for unused fuel. In a transition region 7 between the fluid outlet opening 2d and the adjacent distributor field 3, the first half-sheet 1a has a third step 8c′ and a fourth step 8d′ in the direction of the second half-sheet 1b, starting from the fluid outlet opening 2d. The second half-sheet 1b is provided, in the region of the third step 8c′ in the first half-sheet 1a, with a first step 8a′ in the direction of the first half-sheet 1a, starting from the fluid outlet opening 2d, and with a second step 8b′ in the region of the fourth step 8d′ in the first half-sheet 1a, which second step is directed away from the first half-sheet 1a. In a region between its third step 8c′ and its fourth step 8d', the first half-sheet 1a has elongated three-dimensional further first embossed structures 9a′ which are oriented parallel to one another and are curved in the direction of the second half-sheet 1b. The second half-sheet 1b has, in a region between its first step 8a′ and its second step 8b', elongated three-dimensional further second embossed structures 9b′ which are oriented parallel to one another and are curved in the direction of the first half-sheet 1a, are arranged in alignment with the further first embossed structures 9a′ and are supported against the further first embossed structures 9a′. The first half-sheet 1a has a third sealing region 6c, which is formed in the region of the further first embossed structures 9a′ on the side of the first half-sheet 1a facing away from the second half-sheet 1b and is arranged to run transverse to the further first embossed structures 9a′ and to fill them. The further first embossed structures 9a′ are filled accordingly with sealing compound and stiffened.

The second half-sheet 1b has a fourth sealing region 6d, which is arranged in the region of the further second embossed structures 9b′ on the side of the second half-sheet 1b facing away from the first half-sheet 1a so as to run transverse to the further second embossed structures 9b′ and fill them. The further second embossed structures 9b′ are filled accordingly with sealing compound and stiffened.

The third sealing region 6c in the form of a flat seal and the fourth sealing region 6d comprising two sealing bulges 10a, 10b running parallel to one another run congruently one above the other when viewed perpendicular to a plane spanned by the bipolar plate 1 and thus run parallel on side A and side B of the bipolar plate 1.

The second half-sheet 1b has a further opening slot 11′, which is arranged between its second step 8b′ and the adjacent distributor field 3, and there are three-dimensional further third embossed structures 9c', which are curved in the direction of the first half-sheet 1a. The further second embossed structures 9b′ and the further third embossed structures 9c′ are arranged in alignment in a fluid flow direction S and are supported against the first half-sheet 1a. The further opening slot 11′is arranged such that the further third embossed structures 9c′ arranged in the second half-sheet 1b are intersected by it.

Accordingly, during the formation of the further opening slot 11′, a part of the second half-sheet 1b was separated out which contained a part of the previously formed further third embossed structures 9c′.

On side B of the bipolar plate 1, as described above and shown in FIGS. 2 and 8, accordingly there are the inlet and outlet for the fuel gas, in particular in the form of hydrogen.

Also on side A of the bipolar plate 1 according to FIG. 1 there is an arrangement for the inlet and outlet of a fluid in the form of an oxidizing agent, such as in particular in the form of air or oxygen. The oxidizing agent flows via the fluid inlet opening 2a onto side A of the bipolar plate 1 and thus via an analogous arrangement as in the transition region 7 on side B of the bipolar plate 1 via an opening slot in the first half-plate 1a into a distributor field, onto the active field, into a further distributor field and a further opening slot in the first half-plate 1a in the direction of the fluid outlet opening 2b. For the arrangement in the transition region on side A of the bipolar plate 1, only the designation of the half-plates is to be used in reverse. The basic design for the oxidizing agent inlet and outlet corresponds to that for the fuel inlet and outlet on the side B of the bipolar plate 1.

The fluid inlet opening 2e (see FIG. 1) is designed to supply coolant into a fluid guide path or flow space (not shown in detail) between the two half-plates 1a, 1b of the bipolar plate 1. The coolant flows along the rectangular bipolar plate 1 and into the fluid outlet opening 2f, the geometry of the fluid guide path being predetermined by the two structured half-sheets 1a, 1b. The region between the fluid outlet opening 2f at the transition to the fluid guide path between the half-plates 1a, 1b is not subject to any design specifications and can be designed as desired.

The geometric design of the fluid passage openings 2, the distributor fields 3, 5 and the active field 4 can be varied within wide limits and do not have to be designed as shown in FIGS. 1 to 8.

FIG. 9 shows a schematic three-dimensional representation of a stack arrangement 20 of a plurality of electrochemical cells 12. An electrochemical cell 12 comprises a plurality of bipolar plates 1, 1′and a membrane electrode unit 13 which is arranged in each case between two bipolar plates 1, 1′and which is covered on both sides with a fluid transport layer (not shown separately here). For the sake of a better overview, the distributor fields between the fluid passage openings 2 and the active field 4 have also been omitted. In contrast to FIG. 1, the cross section of the fluid passage openings 2 was designed to be circular.

### LIST OF REFERENCE SIGNS

1, 1′Bipolar plate
1a, 1b Half-sheet
2 Fluid passage opening
2a, 2c, 2e Fluid inlet opening
2b, 2d, 2f Fluid outlet opening
3 First distributor field
4 Active field
5 Second distributor field
6, 6′ Seal
6a First sealing region
6b Second sealing region
6c Third sealing region
6d Fourth sealing region
7 Transition region
8a, 8a′ First step
8b, 8b′ Second step
8c, 8c′ Third step
8d, 8d′ Fourth step
9a, 9a′ First embossed structures
9b, 9b′ Second embossed structures
9c, 9c′ Third embossed structures
10a, 10b Sealing bulge
11, 11′Opening slot
12 Electrochemical cell
13 Membrane electrode unit
20 Stack arrangement
A First side of the bipolar plate
B Second side of the bipolar plate
S Fluid flow direction

1. A bipolar plate comprising:
a first half-sheet; and
a second half-sheet, wherein the first half-sheet and the second half-sheet are connected, wherein the bipolar plate comprises a plurality of fluid passage openings comprising fluid inlet openings and fluid outlet openings, wherein a first distributor field for distributing a fluid, an active field and a second distributor field for distributing the fluid are arranged on both sides of the bipolar plate, and having at least one seal on each side of the bipolar plate,
wherein, in at least one transition region between a fluid passage opening and an adjacent distributor field,
the first half-sheet includes a first step and a second step in the direction of the second half-sheet, starting from a fluid inlet opening,
the second half-sheet is provided in the region of the first step with a third step in the direction of the first half-sheet, starting from the fluid inlet opening, and in the region of the second step is provided with a fourth step which is directed away from the first half-sheet,
the first half-sheet includes, in a region between the first step and the second step, elongated three-dimensional first embossed structures oriented parallel to one another and curved in the direction of the second half-sheet,
the second half-sheet includes, in a region between the third step and the fourth step, elongated three-dimensional second embossed structures oriented parallel to one another and curved in the direction of the first half-sheet and arranged in alignment with the first embossed structures and are supported against the first embossed structures,
the first half-sheet includes a first sealing region is formed in the region of the first embossed structures on the side of the first half-sheet facing away from the second half-sheet and arranged to run transverse to the first embossed structures and to fill them,
the second half-sheet includes a second sealing region arranged in the region of the second embossed structures on the side of the second half-sheet facing away from the first half-sheet so as to run transverse to the second embossed structures and to fill them, wherein the first sealing region and the second sealing region are arranged congruently one above the other when viewed perpendicular to a plane spanned by the bipolar plate, and
the second half-sheet has includes an opening slot is arranged between the fourth step and the adjacent distributor field, wherein three-dimensional third embossed structures curved in the direction of the first half-sheet are arranged in alignment with the second embossed structures in a fluid flow direction and are supported against the first half-sheet wherein the opening slot is arranged such that the third embossed structures arranged in the second half-sheet are intersected by the latter.

2. The bipolar plate according to claim 1, wherein, in at least one transition region between a fluid passage opening and an adjacent distributor field.
the first half-sheet is provided with a third step and a fourth step in the direction of the second half-sheet, starting from a fluid outlet opening,
the second half-sheet is provided in the region of the third step in the first half-sheet with a first step in the direction of the first half-sheet, starting from the fluid outlet opening, and in the region of the fourth step in the first half-sheet is provided with a second step which is directed away from the first half-sheet,
the first half-sheet has, in a region between its third step and its fourth step, elongated three-dimensional further first embossed structures which are oriented parallel to one another and are curved in the direction of the second half-sheet,
the second half-sheet has, in a region between its first step and its second step, elongated three-dimensional further second embossed structures which are oriented parallel to one another and are curved in the direction of the first half-sheet, are arranged in alignment with the further first embossed structures and are supported against the further first embossed structures,
the first half-sheet has a third sealing region, which is formed in the region of the further first embossed structures on the side of the first half-sheet facing away from the second half-sheet and is arranged to run transverse to the further first embossed structures and fill them,
the second half-sheet has a fourth sealing region, which is arranged in the region of the further second embossed structures on the side of the second half-sheet facing away from the first half-sheet so as to run transverse to the further second embossed structures and fill them, and the third sealing region and the fourth sealing region are arranged congruently one above the other when viewed perpendicular to a plane spanned by the bipolar plate, and
the second half-sheet has a further opening slot arranged between its second step and the adjacent distributor field, and three-dimensional further third embossed structures curved in the direction of the first half-sheet arranged in alignment with the further second embossed structures in a fluid flow direction and supported against the first half-sheet, wherein the further opening slot is arranged such that the further third embossed structures arranged in the second half-sheet are intersected by the further opening slot.

3. The bipolar plate according to claim 2, wherein the first sealing region and the third sealing region are each designed as flat seals.

4. The bipolar plate according to claim 2, wherein the second sealing region and the fourth sealing region each have two parallel sealing bulges.

5. The bipolar plate according to claim 1, wherein the first embossed structures and the second embossed structures are oriented with their longitudinal axes in the direction of a fluid flow direction between the fluid passage opening and the adjacent distributor field.

6. The bipolar plate according to claim 1, wherein a first fluid inlet opening for supplying and a first fluid outlet opening for discharging oxidizing gas are configured on a first side of the bipolar plate.

7. The bipolar plate according to claim 1, wherein a second fluid inlet opening for supplying and a second fluid outlet opening for discharging fuel gas are configured on a second side of the bipolar plate.

8. The bipolar plate according to claim 1, wherein each half-sheet is three-dimensionally structured in the region of the first distributor field, the active field and the second distributor field to form fluid guide paths.

9. The bipolar plate according to claim 1, wherein a fluid guide path for a coolant is formed between the first half-sheet and the second half-sheet.

10. An electrochemical cell comprising a plurality of bipolar plates according to claim 1 and a membrane electrode unit arranged in each case between two bipolar plates and covered on both sides in each case with a fluid transport layer.

11. An electrochemical fuel cell comprising:
a first bipolar plate;
a second bipolar plate; and
a membrane electrode unit arranged between the first bipolar plate and the second bipolar plate,
wherein at least one of the first bipolar plate or the second bipolar plate comprises:
a first half-sheet; and
a second half-sheet, wherein the first half-sheet and the second half-sheet are connected,
wherein the bipolar plate comprises a plurality of fluid passage openings comprising fluid inlet openings and fluid outlet openings, wherein a first distributor field for distributing a fluid, an active field and a second distributor field for distributing the fluid are arranged on both sides of the bipolar plate, and having at least one seal on each side of the bipolar plate, and
wherein, in at least one transition region between a fluid passage opening and an adjacent distributor field,
the first half-sheet includes a first step and a second step in the direction of the second half-sheet, starting from a fluid inlet opening,
the second half-sheet is provided in the region of the first step with a third step in the direction of the first half-sheet, starting from the fluid inlet opening, and in the region of the second step is provided with a fourth step which is directed away from the first half-sheet,
the first half-sheet includes, in a region between the first step and the second step, elongated three-dimensional first embossed structures oriented parallel to one another and curved in the direction of the second half-sheet,
the second half-sheet includes, in a region between the third step and the fourth step, elongated three-dimensional second embossed structures oriented parallel to one another and curved in the direction of the first half-sheet, and arranged in alignment with the first embossed structures and are supported against the first embossed structures,
the first half-sheet includes a first sealing region formed in the region of the first embossed structures on the side of the first half-sheet facing away from the second half-sheet and arranged to run transverse to the first embossed structures and to fill them,
the second half-sheet includes a second sealing region arranged in the region of the second embossed structures on the side of the second half-sheet facing away from the first half-sheet so as to run transverse to the second embossed structures and to fill them, wherein the first sealing region and the second sealing region are arranged congruently one above the other when viewed perpendicular to a plane spanned by the bipolar plate, and
the second half-sheet includes an opening slot arranged between the fourth step and the adjacent distributor field, wherein three-dimensional third embossed structures curved in the direction of the first half-sheet are arranged in alignment with the second embossed structures in a fluid flow direction and are supported against the first half-sheet, wherein the opening slot is arranged such that the third embossed structures arranged in the second half-sheet are intersected by the latter.

12. The electrochemical fuel cell according to claim 11, wherein the membrane electrode unit comprises a polymer electrolyte membrane.

13. The electrochemical fuel cell according to claim 11, wherein, in at least one transition region between a fluid passage opening and an adjacent distributor field,
the first half-sheet is provided with a third step and a fourth step in the direction of the second half-sheet, starting from a fluid outlet opening,
the second half-sheet is provided in the region of the third step in the first half-sheet with a first step in the direction of the first half-sheet, starting from the fluid outlet opening, and in the region of the fourth step in the first half-sheet is provided with a second step which is directed away from the first half-sheet,
the first half-sheet has, in a region between its third step and its fourth step, elongated three-dimensional further first embossed structures which are oriented parallel to one another and are curved in the direction of the second half-sheet,
the second half-sheet has, in a region between its first step and its second step, elongated three-dimensional further second embossed structures which are oriented parallel to one another and are curved in the direction of the first half-sheet, are arranged in alignment with the further first embossed structures and are supported against the further first embossed structures,
the first half-sheet has a third sealing region, which is formed in the region of the further first embossed structures on the side of the first half-sheet facing away from the second half-sheet and is arranged to run transverse to the further first embossed structures and fill them,
the second half-sheet has a fourth sealing region, which is arranged in the region of the further second embossed structures on the side of the second half-sheet facing away from the first half-sheet so as to run transverse to the further second embossed structures and fill them, and the third sealing region and the fourth sealing region are arranged congruently one above the other when viewed perpendicular to a plane spanned by the bipolar plate, and
the second half-sheet has a further opening slot arranged between its second step and the adjacent distributor field, and three-dimensional further third embossed structures curved in the direction of the first half-sheet, arranged in alignment with the further second embossed structures in a fluid flow direction and supported against the first half-sheet, wherein the further opening slot is arranged such that the further third embossed structures arranged in the second half-sheet are intersected by the further opening slot.

14. An electrochemical electrolysis cell for electrolysis of water comprising:
a first bipolar plate;
a second bipolar plate; and
a membrane electrode unit arranged between the first bipolar plate and the second bipolar plate,
wherein at least one of the first bipolar plate or the second bipolar plate comprises:
a first half-sheet; and
a second half-sheet, wherein the first half-sheet and the second half-sheet are connected,
wherein the bipolar plate comprises a plurality of fluid passage openings comprising fluid inlet openings and fluid outlet openings, wherein a first distributor field for distributing a fluid, an active field and a second distributor field for distributing the fluid are arranged on both sides of the bipolar plate, and having at least one seal on each side of the bipolar plate, and
wherein, in at least one transition region between a fluid passage opening and an adjacent distributor field,
the first half-sheet includes a first step and a second step in the direction of the second half-sheet, starting from a fluid inlet opening,
the second half-sheet is provided in the region of the first step with a third step in the direction of the first half-sheet, starting from the fluid inlet opening, and in the region of the second step is provided with a fourth step which is directed away from the first half-sheet,
the first half-sheet includes, in a region between the first step and the second step, elongated three-dimensional first embossed structures oriented parallel to one another and curved in the direction of the second half-sheet,
the second half-sheet includes, in a region between the third step and the fourth step, elongated three-dimensional second embossed structures oriented parallel to one another and curved in the direction of the first half-sheet, and arranged in alignment with the first embossed structures and are supported against the first embossed structures,
the first half-sheet includes a first sealing region formed in the region of the first embossed structures on the side of the first half-sheet facing away from the second half-sheet and arranged to run transverse to the first embossed structures and to fill them,
the second half-sheet includes a second sealing region arranged in the region of the second embossed structures on the side of the second half-sheet facing away from the first half-sheet so as to run transverse to the second embossed structures and to fill them, wherein the first sealing region and the second sealing region are arranged congruently one above the other when viewed perpendicular to a plane spanned by the bipolar plate, and
the second half-sheet includes an opening slot arranged between the fourth step and the adjacent distributor field, wherein three-dimensional third embossed structures curved in the direction of the first half-sheet are arranged in alignment with the second embossed structures in a fluid flow direction and are supported against the first half-sheet, wherein the opening slot is arranged such that the third embossed structures arranged in the second half-sheet are intersected by the latter.

15. The electrochemical electrolysis cell according to claim 14, wherein the membrane electrode unit comprises a polymer electrolyte membrane.

16. The electrochemical electrolysis cell according to claim 14, wherein, in at least one transition region between a fluid passage opening and an adjacent distributor field,
the first half-sheet is provided with a third step and a fourth step in the direction of the second half-sheet, starting from a fluid outlet opening,
the second half-sheet is provided in the region of the third step in the first half-sheet with a first step in the direction of the first half-sheet, starting from the fluid outlet opening, and in the region of the fourth step in the first half-sheet is provided with a second step which is directed away from the first half-sheet,
the first half-sheet has, in a region between its third step and its fourth step, elongated three-dimensional further first embossed structures which are oriented parallel to one another and are curved in the direction of the second half-sheet,
the second half-sheet has, in a region between its first step and its second step, elongated three-dimensional further second embossed structures which are oriented parallel to one another and are curved in the direction of the first half-sheet, are arranged in alignment with the further first embossed structures and are supported against the further first embossed structures,
the first half-sheet has a third sealing region, which is formed in the region of the further first embossed structures on the side of the first half-sheet facing away from the second half-sheet and is arranged to run transverse to the further first embossed structures and fill them,
the second half-sheet has a fourth sealing region, which is arranged in the region of the further second embossed structures on the side of the second half-sheet facing away from the first half-sheet so as to run transverse to the further second embossed structures and fill them, and the third sealing region and the fourth sealing region are arranged congruently one above the other when viewed perpendicular to a plane spanned by the bipolar plate, and
the second half-sheet has a further opening slot arranged between its second step and the adjacent distributor field, and three-dimensional further third embossed structures curved in the direction of the first half-sheet, arranged in alignment with the further second embossed structures in a fluid flow direction and supported against the first half-sheet, wherein the further opening slot is arranged such that the further third embossed structures arranged in the second half-sheet are intersected by the further opening slot.
